(19) United States
(12) Patent Application Publication
(10) Pub. No.: US 2006/0230660 A1
(43) Pub. Date: Oct. 19, 2006

(54) Multi-purpose golf course kiosk

(76) Inventor: Michael D. Harper, Fort Worth, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 11/370,342

(22) Filed: Mar. 8, 2006

Related U.S. Application Data
(60) Provisional application No. 60/671,920, filed on Apr. 15, 2005.

(51) Int. Cl. G09F 15/00

(52) U.S. Cl. 40/606.03

(57) ABSTRACT

A multi-purpose golf course kiosk, comprising a housing and a display device disposed within the housing. The display device comprises a window and a pivotally mounted backing panel for supporting an object to be displayed through the window.

### CROSS REFERENCE TO RELATED APPLICATION

This application claims the benefit of U.S. Provisional Patent Application Ser. No. 60/671,920 filed Apr. 15, 2005 titled Golfer Restoration Center.

### BACKGROUND OF THE INVENTION

Golf courses provide the golfer an opportunity to enjoy scenic surroundings. However, numerous devices, especially around the tee-box areas, tend to clutter or detract from the natural beauty of a golf course and its surroundings. For example, golf courses oftentimes have ball washing stations, trash receptacles, water fountains, advertisements, etc. around the tee-box, which due to the numerous structures, can detract from a course's natural beauty. Further, many signs used for displaying information and/or advertisements, for example, are incapable of protecting the displayed information from inclement weather conditions (e.g., rain, ultraviolet rays, etc.) and are unable to provide an adequate level of security to prevent unauthorized third-parties from removing and/or tampering with the displayed information.

### BRIEF DESCRIPTION OF THE DRAWINGS

For a more complete understanding of the present invention and the advantages thereof, reference is now made to the following descriptions taken in connection with the accompanying drawings in which:

FIG. 1 is a front perspective view of the multi-purpose golf course kiosk in accordance with an embodiment of the present invention;

FIG. 2 is a front perspective view of the multi-purpose golf course kiosk of FIG. 1 in accordance with the present invention;

FIG. 3 is a diagram illustrating a locking mechanism of the multi-purpose golf course kiosk in accordance an embodiment of the present invention;

FIG. 4 is a rear elevation view of the multi-purpose golf course kiosk of FIG. 1; and

FIG. 5 is a front perspective view of another embodiment of a multi-purpose golf course kiosk comprising an electronic display device in accordance with the present invention.

### DETAILED DESCRIPTION OF THE DRAWINGS

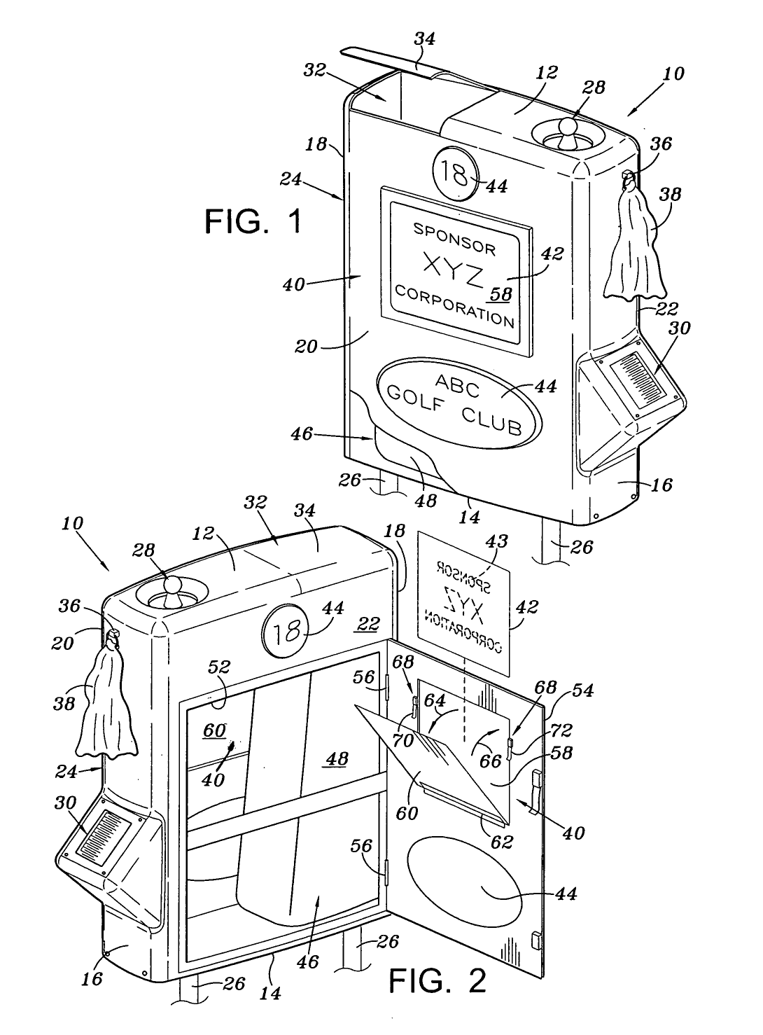

The preferred embodiments of the present invention and the advantages thereof are best understood by referring to FIGS. 1-5 of the drawings, like numerals being used for like and corresponding parts of the various drawings.

FIG. 1 is a diagram illustrating an embodiment of a multi-purpose golf course kiosk 10 in accordance with an embodiment of the present invention. In the embodiment illustrated in FIG. 1, multi-purpose golf course kiosk 10 comprises a top surface 12, a bottom surface 14, a front surface 16, a rear surface 18 and a pair of side surfaces 20 and 22 forming a housing 24. One or more support members 26 extends from bottom surface 14 to support housing 24 above ground level; however, it should be understood that housing 24 may be configured to rest directly on the ground (e.g., without supports member 26) or supported by any other type of method or structure. In the embodiment illustrated in FIG. 1, kiosk 10 comprises a golf ball washer 28, a golf club cleaner 30, a storage compartment 32 having a cover 34, a ring 36 for supporting a towel 38, and at least one display device 40 disposed within housing 24 for displaying an object 42, such as, but not limited to, advertisements, course diagrams and announcements. In the embodiment illustrated in FIG. 1, display device 40 is disposed on side surface 20; however, it should be understood that additionally or alternatively, display device 40 may be otherwise disposed (e.g., on surfaces 12, 16, 18 and/or 22). In the embodiment illustrated in FIG. 1, display device 40 is secured within and accessible through the interior of housing 24 to provide protection from weather elements such as rain and/or snow while also reducing the likelihood of an unauthorized third-party removing and/or tampering with object 42 in display device 40.

In the embodiment illustrated in FIG. 1, kiosk 10 comprises at least one identifier platform 44 disposed on side surface 20 for displaying information such as a golf course name and/or golf course hole number; however, it should be understood that identifier platform 44 may be otherwise disposed (e.g., on surfaces 12, 16, 18 and/or 22) and may display other information thereon. In the embodiment illustrated in FIG. 1, identifier platform 44 is integral (i.e., a single unitary body) with housing 24; however, it should be understood that identifier platform 44 can be a separate device removably coupleable to housing 24.

In the embodiment illustrated in FIG. 1, housing 24 is configured to receive a trash receptacle 46 such as a trash bag 48 in order to receive and store trash. Trash may be disposed within housing 24 (and bag 48) via an opening 50 (FIG. 4).

FIG. 2 is a front perspective view of the multi-purpose golf course kiosk 10 of FIG. 1 in accordance with the present invention. In the embodiment illustrated in FIG. 2, side surface 22 comprises an opening 52 to enable access to the interior of housing 52 to install or remove object 42 to or from display device 40, to replace trash bag 48, for servicing ball washer 28 and/or servicing club cleaner 30. Side surface 22 comprises a door 54 pivotally attached to side surface 22 by hinges 56 to enclose opening 52 and prevent access inside housing 24.

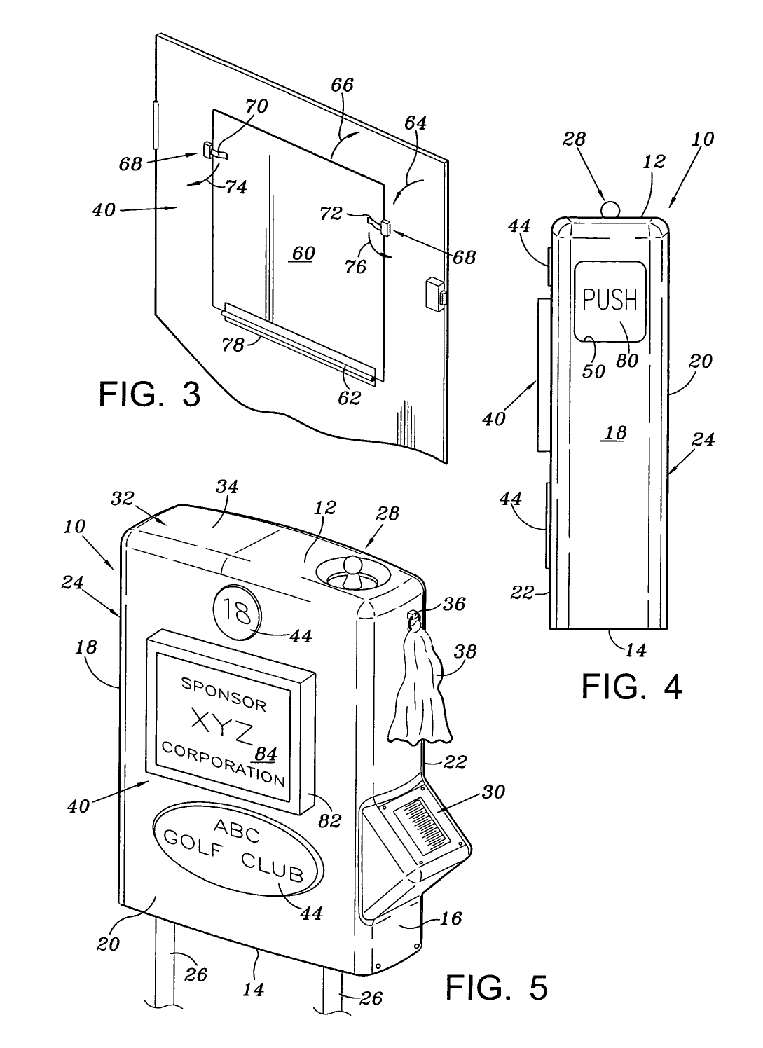

In the embodiment illustrated in FIG. 2, a display device 40 is disposed on side surface 20 and on door 54 of side surface 22. According to embodiments of the present invention, display device 40 comprises a window 58 to enable viewing of object 42 and a backing panel 60 pivotally coupled to housing 24 via a hinge 62. In operation, backing panel 60 is opened by pivoting backing panel 60 in the direction indicated by arrow 64 to configure display device 40 in an open position, as illustrated in FIG. 2. When backing panel 60 is in the open position, a user may insert object 42 between backing panel 60 and display window 58 (with viewable content 43 oriented toward window 58). In operation, object 42 is disposed within display device 40 either by placing object 42 directly on backing panel 60, or, in the alternative, by directly placing object 42 adjacent to window 58 with viewable content 43 oriented toward window 58. Once the object is disposed between panel 60 and window 58, backing panel 60 is pivoted in the direction indicated by arrow 66 to a closed position (FIG. 3) so as to support object 42 upright in a position adjacent to window 58 to enable object 42 to be clearly viewed through window 58.

FIG. 3 is a diagram illustrating a locking mechanism 68 of display device 40 in accordance an embodiment of the present invention. In the embodiment illustrated in FIG. 3, display device 40 is in the closed position (e.g., backing panel 60 is positioned upright and adjacent to window 58) for supporting object 42. Locking mechanism 68 comprises a pair of locking clips 70 and 72 operable to maintain backing panel 60 in the closed position. Accordingly, in operation, object 42 is supported by window 58 and backing panel 60 so that the viewable portion of object 42 is directly adjacent to and viewable through window 58. It should be understood that embodiments of the present invention enable object 42 to be protected from weather elements such as rain or snow and likewise, to secure object 42 from unauthorized third parties damaging and/or removing object 42 from kiosk 10.

In the embodiment illustrated in FIG. 3, when it is desired to return display device 40 to an open position, locking clips 70 and 72 are pivoted away from backing panel 60 in the direction indicated by arrows 74 and 76 to enable backing panel 60 to be pivoted in the direction of arrow 64 to the open position (FIG. 2). While in the open position, object 42 may be removed from display device 40. Additionally or alternatively, hinge 62 can comprise a spring biased hinge 78 to bias backing panel 60 to a closed position thereby avoiding the necessity of locking clips 70 and 72.

FIG. 4 is a diagram illustrating rear surface 18 of multi-purpose golf course kiosk 10. In the embodiment illustrated in FIG. 4, rear surface 18 comprises opening 50 having a door 80 pivotally attached to housing 24 to enable access inside housing 24 for disposing trash inside bag 48 (FIGS. 1 and 2). Pivotal door 80 is spring loaded to bias door 80 in a closed position to enclose housing 24 to contain any odors generated from refuse within housing 24.

FIG. 5 is a diagram illustrating another embodiment of multi-purpose golf course kiosk 10 in accordance with the present invention. In the embodiment illustrated in FIG. 5, multi-purpose kiosk 10 display device 40 comprises an electronic display device 82. According to an embodiment of the present invention, electronic display device 82 may comprise a liquid crystal display (“LCD”) 84, by way of example. Electronic display device 82 provides a dynamic display and is used to provide displayed data, such as, but not limited to, current events, weather, sports scores, news, advertisements, announcements, golf course diagrams, etc.

Other alterations and modifications of the present invention will likewise become apparent to those of ordinary skill in the art upon reading the present disclosure, and it is intended that the scope of the invention disclosed herein be limited only by the broadest interpretation of the appended claims to which the inventor is legally entitled.

What is claimed is:

1. A multi-purpose golf course kiosk, comprising:
a housing; and
a display device disposed within the housing, the display device having a window and a pivotally mounted backing panel for supporting an object to be displayed through the window.

2. The multi-purpose kiosk of claim 1, wherein the housing is defined by a top surface, a bottom surface, a front surface, a rear surface and a pair of side surfaces, at least one of the side surfaces comprising a door to access the housing.

3. The multi-purpose kiosk of claim 2, wherein the display device is disposed on the door.

4. The multi-purpose kiosk of claim 2, wherein a second display device is disposed on at least one of the sidewalls.

5. The multi-purpose kiosk of claim 1, wherein the display device further comprises a locking mechanism to prevent movement of the backing panel relative to the window.

6. The multi-purpose kiosk of claim 1, wherein the backing panel is biased against the window.

7. The multi-purpose kiosk of claim 1, wherein the display device is accessible through an opening disposed on a surface of the housing.

8. The multi-purpose kiosk of claim 1, wherein the housing is configured to receive a trash receptacle.

9. The multi-purpose kiosk of claim 1, wherein the housing comprises a golf club cleaner.

10. A method of manufacturing a multi-purpose golf course kiosk, comprising:
providing a housing; and
providing a display device disposed within the housing, the display device having a window and a pivotally mounted backing panel for supporting an object to be displayed through the window.

11. The method of claim 10, wherein providing the housing comprises providing a top surface, a bottom surface, a front surface, a rear surface and a pair of side surfaces, at least one of the side surfaces comprising a door to access the housing.

12. The method of claim 11, further comprising disposing the display device on the door.

13. The method of claim 11, further comprising providing a second display device on at least one of the sidewalls.

14. The method of claim 10, further comprising providing a locking mechanism to prevent movement of the backing panel relative to the window.

15. The method of claim 10, further comprising biasing the backing panel toward the window.

16. The method of claim 10, wherein providing the display device comprises providing the display device accessible through an opening disposed on a surface of the housing.

17. A multi-purpose kiosk, comprising:
a housing defined by a top wall, a bottom wall, a front wall, a rear wall and a first and second sidewall, wherein the housing comprises a golf ball washer;
an electronic display device coupled to the housing, the electronic display device having a display screen adapted to provide a displayed message thereon.

18. The multi-purpose kiosk of claim 17, wherein the housing further comprises a golf club cleaner.

19. The multi-purpose kiosk of claim 10, wherein the electronic display comprises a liquid crystal display.

20. The multi-purpose kiosk of claim 17, wherein the housing comprises a door to access the interior of the housing.
